(19) United States
(12) Patent Application Publication
(10) Pub. No.: US 2011/0274282 A1
(43) Pub. Date: Nov. 10, 2011

(54) Multi microphone sampling method and circuit with single ADC front end

(76) Inventor: Alon Konchitsky, Cupertino, CA (US)

(21) Appl. No.: 13/103,823

(22) Filed: May 9, 2011

Related U.S. Application Data
(60) Provisional application No. 61/332,785, filed on May 9, 2010.

(51) Int. Cl. G10K 11/16

(52) U.S. Cl. 381/71.1

(57) ABSTRACT

The invention relates generally to means and methods of improving the Signal to Noise Ratio (SNR) in communication devices. In particular, means and methods of alternating microphone inputs are disclosed. Multiple microphones are used to increase the SNR in a communication device that is capable of storing the input from only one microphone at a time. By alternating the inputs from the microphones and storing the inputs, multi-channel noise reduction techniques are employed in a system similar to a single channel system. Existing sigma-delta analog to digital converters may be used to time the switching between the microphones alternately. The microphones may be switched by relays, flip-flops, transistors, or other means. As the SNR is improved, traffic in a communications network may be increased by increasing the number of users in response to the lower bandwidth required.

### CROSS-REFERENCE TO A RELATED APPLICATION

This non-provisional patent application claims the priority date and benefit of provisional patent application 61/332,785 filed on May 9, 2010, the entire contents of which are incorporated herein by reference.

### REFERENCES CITED

### U.S. Patent Documents

| | | |
|---|---|---|
| 5,406,622 | April 1995 | Silverberg et al |
| 6,415,034 | July 2002 | Hietanen |
| 5,969,838 | October 1999 | Paritsky et al |

### OTHER REFERENCES

Bernard Widrow and Samuel D. Stearns, “Adaptive Signal Processing”, Pearson Education

### BACKGROUND

1. Field of the Invention

The invention relates generally to means and methods of improving the signal to noise ratio in the communication devices. In particular, means and methods of alternating microphone inputs are disclosed. The resulting increase in SNR uses less bandwidth and may be tracked by a communication network and allows more users to be supported by the communication network.

2. Background of the Invention

Voice communication devices such as cell phones, wireless phones and devices other than cell phones have become ubiquitous; they show up in almost every environment. These systems and devices and their associated communication methods are referred to by a variety of names, such as but not limited to, cellular telephones, cell phones, mobile phones, wireless telephones in the home and the office, and devices such as Personal Data Assistants (PDA^{s}) that include a wireless or cellular telephone communication capability. They are used at home, office, inside a car, a train, at the airport, beach, restaurants and bars, on the street, and almost any other venue. As might be expected, these diverse environments have relatively higher and lower levels of background, ambient, or environmental noise. For example, there is generally less noise in a quiet home than there is in a crowded bar. If this noise, at sufficient levels, is picked up by the microphone, the intended voice communication degrades and though possibly not known to the users of the communication device, uses up more bandwidth or network capacity than is necessary, especially during non-speech segments in a two-way conversation when a user is not speaking.

A cellular network is a radio network made up of a number of radio cells (or just cells) each served by a fixed transmitter, normally known as a base station. These cells cover different geographical areas in order to provide coverage over a wider geographical area than the area of one cell. Cellular networks are inherently asymmetric with a set of fixed main transceivers each serving a cell and a set of distributed (generally, but not always, mobile) transceivers which provide services to the network's users.

The primary requirement for a cellular network is that each of the distributed stations need to distinguish signals from their own transmitter and signals from other transmitters. There are two common solutions to this requirement: Frequency Division Multiple Access (FDMA) and Code Division Multiple Access (CDMA). FDMA works by using a different frequency for each neighboring cell. By tuning to the frequency of a chosen cell, the distributed stations can avoid the signals from other neighbors. The principle of CDMA is more complex, but achieves the same result; the distributed transceivers can select one cell and listen to it. Other available methods of multiplexing such as Polarization Division Multiple Access (PDMA) and Time Division Multiple Access (TDMA) cannot be used to separate signals from one cell to the other since the effects of both vary with position, which makes signal separation practically impossible. Orthogonal Frequency Division Multiplexing (OFDM), in principle, consists of frequencies orthogonal to each other. TDMA, however, is used in combination with either FDMA or CDMA in a number of systems to give multiple channels within the coverage area of a single cell.

The wireless world comprises the following exemplary, but not limited to the communication schemes: time based and code based. In the cellular mobile environment these techniques are named as TDMA (Time Division Multiple Access) which comprises, but not limited to the following standards GSM, GPRS, EDGE, IS-136, PDC, and the like; and CDMA (Code Division Multiple Access) which comprises, but not limited to the following standards: CDMA One, IS-95A, IS-95B, CDMA 2000, CDMA 1xEvDv, CDMA 1xEvDo, WCDMA, UMTS, TD-CDMA, TDS-DMA, OFDM, WiMax, WiFi, and others).

For the code division based standards or the orthogonal frequency division, as the number of subscribers grow and average minutes per month increase, more and more mobile calls typically originate and terminate in noisy environments. The background or ambient noise degrades the voice quality.

For the time based schemes, like GSM, GPRS and EDGE schemes, improving the end-users signal-to-noise ratio (SNR), improves the listening experience for users of existing TDMA based networks. This is done by improving the received speech quality by employing background noise reduction or cancellation at the sending or transmitting device.

Significantly, in an on-going cell phone call or other communication from an environment having relatively higher environmental noise, it is sometimes difficult for the party at the other end of the conversation to hear what the party in the noisy environment is saying. That is, the ambient or environmental noise in the environment often “drowns out” the cell phone user's voice, whereby the other party cannot hear what is being said or even if they can hear it with sufficient volume the voice or speech is not understandable. This problem may even exist in spite of the conversation using a high data rate on the communication network.

Attempts to solve this problem have largely been unsuccessful. Both single microphone and two microphone approaches have been attempted. For example, U.S. Pat. No. 6,415,034 to Hietanen et al patent describes the use of a second background noise microphone located within an earphone unit or behind an ear capsule. Digital signal processing is used to create a noise canceling signal which enters the speech microphone. Unfortunately, the effectiveness of the method disclosed in the Hietanen et al patent is compromised by acoustical leakage, which is where the ambient or environmental noise leaks past the ear capsule and into the speech microphone. The Hietanen et al patent also relies upon complex and power consuming expensive digital circuitry that may generally not be suitable for small portable battery powered devices such as pocket able cellular telephones.

Another example is U.S. Pat. No. 5,969,838 (the “Paritsky patent”) which discloses a noise reduction system utilizing two fiber optic microphones that are placed side-by-side next to one another. Unfortunately, the Paritsky patent discloses a system using light guides and other relatively expensive and/or fragile components not suitable for the rigors of cell phones and other mobile devices. Neither Paritsky nor Hietanen address the need to increase capacity in cell phone-based communication systems.

U.S. Pat. No. 5,406,622 to Silverberg et al uses two adaptive filters, one driven by the handset transmitter to subtract speech from a reference value to produce an enhanced reference signal; and a second adaptive filter driven by the enhanced reference signal to subtract noise from the transmitter. Silverberg et al require accurate detection of speech and non-speech regions. Any incorrect detection will degrade the performance of the system.

Previous approaches in noise cancellation have included passive expander circuits used in the electret-type telephonic microphone. These, however, suppress only low level noise occurring during periods when speech is not present. Passive noise-canceling microphones are also used to reduce background noise. These have a tendency to attenuate and distort the speech signal when the microphone is not in close proximity to the user's mouth; and further are typically effective only in a frequency range up to about 1 kHz.

Active noise-cancellation circuitry to reduce background noise has been suggested which employs a noise-detecting reference microphone and adaptive cancellation circuitry to generate a continuous replica of the background noise signal that is subtracted from the total background noise signal before it enters the network. Most such arrangements are still not effective. They are susceptible to cancellation degradation because of a lack of coherence between the noise signal received by the reference microphone and the noise signal impinging on the transmit microphone. Their performance also varies depending on the directionality of the noise; and they also tend to attenuate or distort the speech.

Hence there is a need in the art for a method of noise reduction or cancellation that is robust, suitable for mobile use, and inexpensive to manufacture. The increased traffic in cellular telephone based communication systems has created a need in the art for means to provide a clear, high quality signal with a high signal-to-noise ratio.

The requirements of a noise reduction system for speech enhancement are a) Intelligibility and naturalness of the enhanced signal, b) Improvement of the signal-to-noise ratio, c) Short signal delay and d) Computational simplicity

There are several methods for performing noise reduction, but all can be categorized as types of filtering. In the related art, speech and noise are mixed into one signal channel, where they reside in the same frequency band and may have similar correlation properties. Consequently, filtering will inevitably have an effect on both the speech signal and the background noise signal. Distinguishing between voice and background noise signals is a challenging task. Speech components may be perceived as noise components and may be suppressed or filtered along with the noise components.

Even with the availability of modern signal-processing techniques, a study of single-channel systems shows that significant improvements in SNR are not obtained using a single channel or a one microphone approach. Surprisingly, most noise reduction techniques use a single microphone system and suffer from the shortcoming discussed above.

One way to overcome the limitations of a single microphone system is to use multiple microphones where one microphone may be closer to the speech signal than the other microphone. Exploiting the spatial information available from multiple microphones has led to substantial improvements in voice clarity or SNR in multi-channel systems. However, the current multi-channel systems use separate front-end circuitry for each microphone, and thus increase hardware expense and power consumption.

Hence, there is a room in the art for new means and methods of increasing SNR in hand-held devices that capture sound with multiple microphones but use the circuitry or hardware of a single channel system.

Adaptive noise cancellation is one such powerful speech enhancement technique based on the availability of an auxiliary channel, known as reference path, where a correlated sample or reference of the contaminating noise is present. This reference input is filtered following an adaptive algorithm, in order to subtract the output of this filtering process from the main path, where noisy speech is present.

As with any system, the multiple microphone systems also suffer from several shortfalls. The first shortfall is that, in certain instances, the available reference input to an adaptive noise canceller may contain low-level signal components in addition to the usual correlated and uncorrelated noise components. These signal components will cause some cancellation of the primary input signal. The maximum signal-to-noise ratio obtained at the output of such noise cancellation system is equal to the noise-to-signal ratio present on the reference input.

The second shortfall is that, for a practical system, both microphones should be worn on the body. This reduces the extent to which the reference microphone can be used to pick up the noise signal. That is, the reference input will contain both signal and noise. Any decrease in the noise-to-signal ratio at the reference input will reduce the signal-to-noise ratio at the output of the system. The third shortfall is that, an increase in the number of noise sources or room reverberation will reduce the effectiveness of the noise reduction system.

### SUMMARY OF THE INVENTION

The present invention overcomes shortfalls in the related art by switching between multiple microphones contained or attached to a single input device. Economies in hardware and power consumption are obtained by multiple microphones sharing the front-end hardware that is typically duplicated for each microphone in traditional multi-channel systems. By coordinating the timing between the alternation of the microphones and the noise reduction circuitry, existing single microphone systems may be economically modified to use multiple microphones.

The invention uses multiple microphones or multiple sources of sound input to reduce environmental or background noise. This has a twofold effect on the speech quality as perceived by the listener. Without noise reduction, the speech coder acts on speech plus noise. Speech coders are designed to reproduce “pure” speech at good quality levels but where the speech signal is corrupted by noise, the performance of the speech coder rapidly degrades. The present invention presents means, methods and techniques to increase intelligibility or SNR by reducing the corrupting noise and allowing the speech coder to work on a filtered signal.

The minimal requirements in terms of MIPS and memory, allow the Baseband DSP present in any communication device to perform the additional computation presented by the invention. Current cell phones allow for multimedia processing and support high sampling rates for audio. When dealing with the band limited speech signals, it is possible to sample simultaneous sources with minor logic changes, thus facilitating the switching of multiple microphones in accordance with the disclosed invention. Switching multiple microphones alternately allows for use of traditional multi-channel noise reduction techniques but with the overhead of a one microphone or single channel system. Fast switching between microphones allows the handset device to store ample input from each microphone to facilitate the noise reduction techniques successfully utilized by current multi-channel systems. Numerous techniques for alternating microphones are contemplated.

There are many advantages of using a multi microphone system. For example, with a music/voice signal of 20 kHz, using only one microphone, the sampling frequency is taken as 40 kHz to satisfy the Nyquist criteria. But, with a multiple microphone system, the signal at each microphone is sampled at 20 kHz, such that the combined sampling frequency is 40 kHz.

The present invention provides a novel system and method for monitoring the noise in the environment in which a communication device is operating and cancels the environmental noise before it is transmitted to the other party so that the party at the other end of the voice communication link can more easily hear what the user is transmitting.

The present invention preferably employs noise reduction and or cancellation technology that is operable to attenuate or even eliminate pre-selected portions of an audio spectrum. By monitoring the ambient or environmental noise in the location in which the communication device is operating and applying noise reduction and/or cancellation protocols at the appropriate time via analog and/or digital signal processing, it is possible to significantly reduce the ambient or background noise to which a party to a cellular telephone call might be subjected.

In one aspect of the invention, the invention provides a system and method that enhances the convenience of using a cellular telephone or other wireless telephone or communications device, even in a location having relatively loud ambient or environmental noise.

In another aspect of the invention, the invention provides a system and method for canceling ambient or environmental noise before the ambient or environmental noise is transmitted to another party.

In yet another aspect of the invention, the invention monitors ambient or environmental noise via a second microphone associated with a cellular telephone, which is different from a first microphone primarily responsible for collecting the speaker's voice, and thereafter cancel the monitored environmental noise.

In still another aspect of the invention, an enable/disable switch is provided on a cellular telephone device to enable/disable the noise reduction.

These and other aspects of the present invention will become apparent upon reading the following detailed description in conjunction with the associated drawings. The present invention overcomes shortfalls in the related art by combining directional microphone solution with an adaptive noise cancellation algorithm. Economies in hardware and power consumption are obtained by multiple microphones sharing the front-end hardware. These modifications, other aspects and advantages will be made apparent when considering the following detailed descriptions taken in conjunction with the associated drawings.

### BRIEF DESCRIPTION OF THE DRAWINGS

FIG. 1 is diagram of an exemplary embodiment of a basic single microphone noise reduction system.

FIG. 2 is diagram of an exemplary embodiment of the invention or “Black Box” integrated into a typical single microphone cell phone chip set.

FIG. 3 is diagram of an exemplary embodiment of the circuit symbol for a relay. Table 1 is a table showing differences between a one and two microphone system.

FIG. 4 is diagram of an exemplary embodiment of the invention implemented with an analog or digital relay switching approach.

FIG. 5 is diagram of an exemplary embodiment of the invention implemented with transistor switching approach.

FIG. 6 is diagram of an exemplary embodiment of a typical T flip flop circuit.

FIG. 7 is diagram of an exemplary embodiment of the invention implemented with a flip-flop approach.

FIG. 8 is diagram of an exemplary embodiment of a Sigma-Delta Architecture.

FIG. 9 is diagram of an exemplary embodiment of typical cell phone architecture.

### DETAILED DESCRIPTION OF EMBODIMENTS OF THE INVENTION

The following detailed description is directed to certain specific embodiments of the invention. However, the invention can be embodied in a multitude of different ways as defined and covered by the claims and their equivalents. In this description, reference is made to the drawings wherein like parts are designated with like numerals throughout.

Unless otherwise noted in this specification or in the claims, all of the terms used in the specification and the claims will have the meanings normally ascribed to these terms by workers in the art.

The present invention provides a novel and unique background noise or environmental noise reduction and/or cancellation feature for a communication device such as a cellular telephone, wireless telephone, cordless telephone, recording device, a handset, and other communications and/or recording devices. While the present invention has applicability to at least these types of communications devices, the principles of the present invention are particularly applicable to all types of communication devices, as well as other devices that process or record speech in noisy environments such as voice recorders, dictation systems, voice command and control systems, and the like.

For simplicity, the following description employs the term “telephone” or “cellular telephone” as an umbrella term to describe the embodiments of the present invention, but those skilled in the art will appreciate the fact that the use of such “term” is not considered limiting to the scope of the invention, which is set forth by the claims appearing at the end of this description.

Hereinafter, preferred embodiments of the invention will be described in detail in reference to the accompanying drawings. It should be understood that like reference numbers are used to indicate like elements even in different drawings. Detailed descriptions of known functions and configurations that may unnecessarily obscure the aspect of the invention have been omitted.

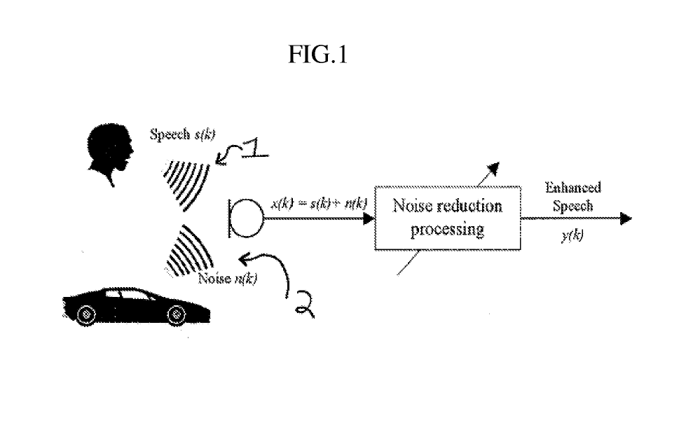

In typical environments where handsets or hands free devices are used, the 1 speech signal entering a transmitting device often competes with 2 background noise as shown in FIG. 1. In some environments, background noise enters a microphone at higher levels than the speech signal. Background noise can distort the speech signal and make words unintelligible. In order to improve speech clarity and to reduce listener stress, in typical signal channel noise reduction equipment, a speech enhancement algorithm is applied which increases the signal to noise ratio (“SNR”).

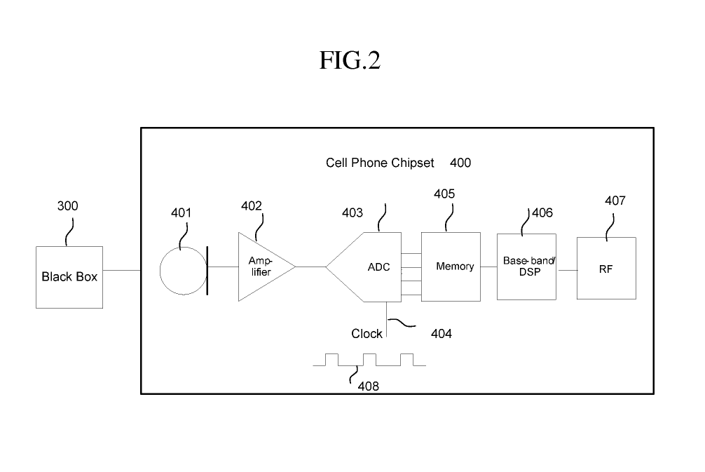

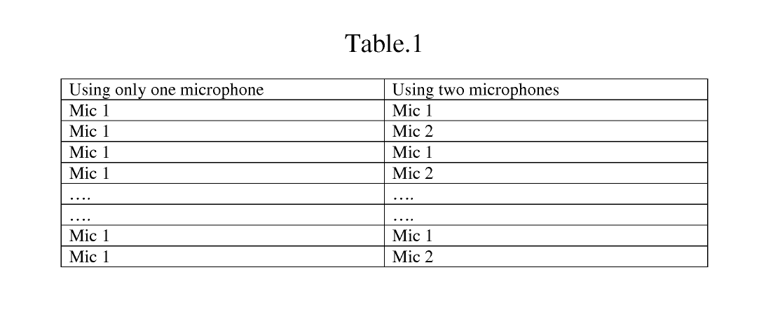

FIG. 2 shows the invention as a 300 Black Box and added to a 400 traditional cell phone chip. Alternate switching between multiple microphones may be accomplished using the logic shown in FIG. 2. The 300 Black Box contains a second microphone and the necessary circuitry or means to switch the multiple microphones alternately. The cell phone chipset 400 blocks contains 401 Microphone 1, 402 Amplifier, 403 Analog Digital Converter (“ADC”) 404 Clock, 405 Memory, 406 Base Band (“BB”)/Digital Processing Unit (“DSP”), 407 Radio Frequency (“RF”). The components of cell phone chipset 400 block are used in present day cell phones and related devices. The Clock frequency 408 may be 20 kHz.

FIG. 2 demonstrates an advantage of the invention where multiple microphones are used, but only one amplifier, ADC, memory, RF or DSP is required. These later components may be called the “front end” components that are typically duplicated for each microphone used in typical multi-channel noise reduction systems.

Table 1 shows the comparison of the contents of memory for a one microphone and a two microphone approach. This approach can be extended for multiple microphones. The table shows the contents of the memory using a one microphone and two microphone approach. The signal processing and/or analog processing techniques of the invention use two or more microphones and switch them alternately.

The invention contemplates numerous methods of switching between two or more microphones. The circuitry or components of the Black Box that switch two or more microphones alternately may be implemented using any of the flowing components a) analog or digital relay, b) Transistor, c) Flip-Flop

A relay is an electrically operated switch. The switch is operated by an electromagnet to open or close one or many sets of contacts. Current flowing through the coil of a relay creates a magnetic field which attracts a lever and changes the switch contacts. Relays allow one circuit to switch a second circuit which can be completely separate from the first.

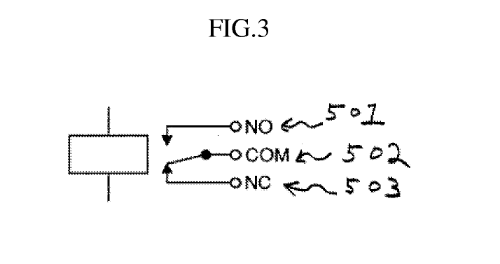

The schematic of a typical relay is shown in FIG. 3. 501 NO is an abbreviation for “Normally Open”—which is an open circuit. 502 COM is an abbreviation for “Common”. 503 NC is an abbreviation for “Normally Closed”—which is a short circuit.

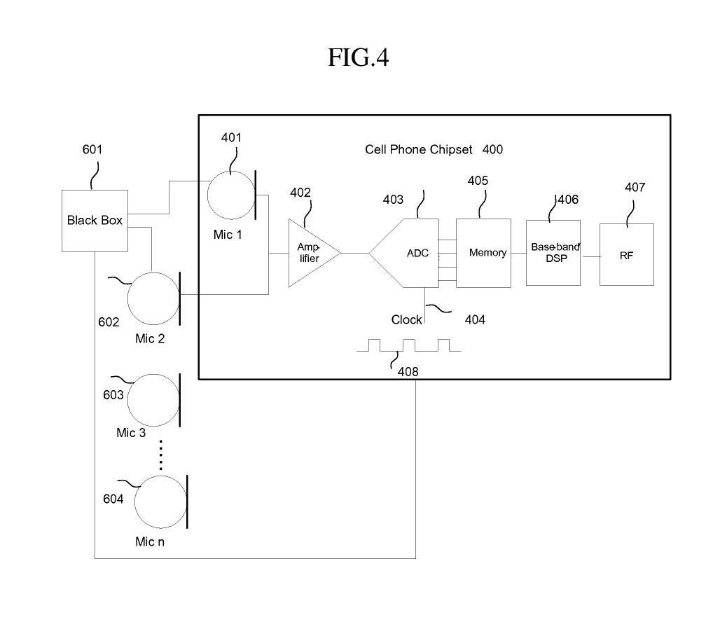

FIG. 4 illustrates a practical implementation of a multi microphone switching approach using relays for the signal processing and/or analog processing techniques. 601 Analog or Digital Relay along with 602 Mic 2, 603 Mic 3 and 604 Mic n replace the Black Box to implement the principles of the invention. The clock frequency is 20 kHz. The sampling frequency is chosen as 40 kHz. Blocks 400 through 408 perform the same functions as described in FIG. 2. The advantage of relays include a) Relays can switch AC and DC, transistors can only switch DC. b) Relays can switch high voltages. c) Relays are a better choice for switching large currents (>5A). d) Relays can switch many contacts at once.

Disadvantages of relays include a) Relays are bulkier than transistors for switching small currents. Relays cannot switch rapidly (except reed relays), transistors can switch many times per second. Relays use more power due to the current flowing through their coil. Relays require more current than many chips can provide, so a low power transistor may be needed to switch the current for the relay's coil.

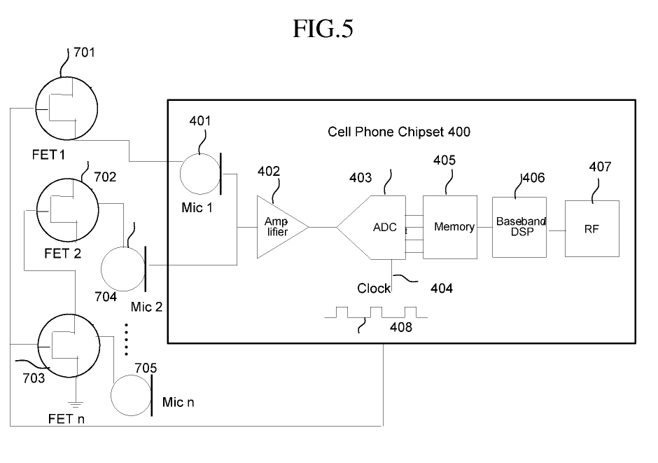

FIG. 5 illustrates a practical implementation of a multi microphone switching signal processing or/and analog processing approach using transistors 701, 702, and 703. The clock frequency is 20 kHz. The sampling frequency is chosen as 40 kHz. The signal processing or/and analog processing techniques use 703 a transistor (FET n) which acts as a switch. The switch alternates MIC 1, 401 and MIC 2, 704. The switching frequency in this case is around 10 kHz. Blocks 400 through 408 perform the same functions as described in FIG. 2.

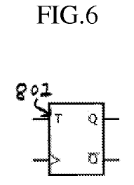

A T flip flop may be used as a switch to switch multiple microphones alternately. FIG. 6 illustrates a T flip flop schematic. If the 801 T input is high, the T flip flop changes state or “toggles” whenever the clock input is strobed. If the 801 T input is low, the lip flop holds the previous value. The T flip-flop gives an output which is half the frequency of the signal to the T input.

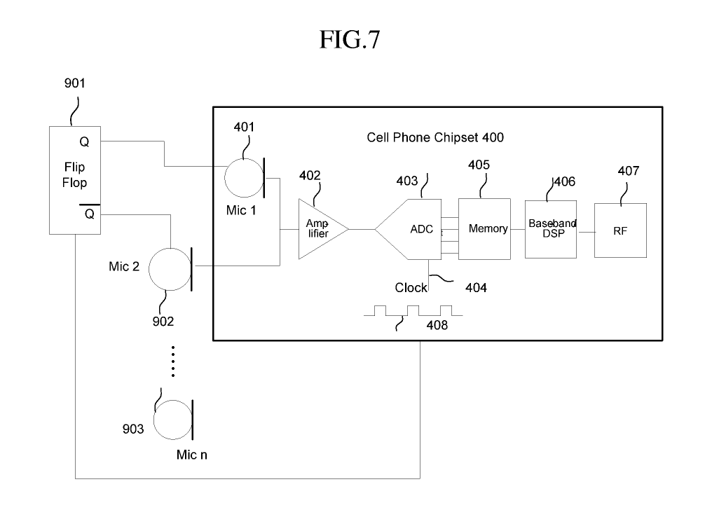

FIG. 7 illustrates a practical implementation of a multi microphone switching approach using a flip-flop for the signal processing and/or analog processing techniques. The 901 Flip-Flop circuit and Mic 2, 902 replace or implement the Black Box. Blocks 400 through 408 perform the same functions as described in FIG. 2.

The most common Analog-to-Digital-Converters or (“ADCs”) used in cellular phones are sigma-delta ADCs that utilize over sampling. Thus, it becomes relatively simple to add a second microphone using the ADC clock to switch between the microphones. The sigma-delta ADC may be considered as a very high sampling rate ADC with 1-bit resolution. The bit stream from the ADC is then averaged and down-sampled to achieve improved resolution at a lower effective sampling rate. The averaging can be accomplished with a Finite Impulse Response (FIR) digital filter.

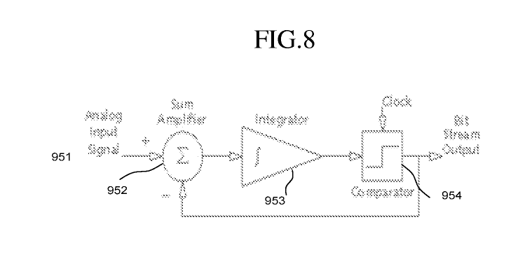

A typical sigma-delta ADC is illustrated in FIG. 8. The 951 analog input signal and a bit stream whose bit density of 1's bits is a representation of the magnitude of the analog signal are fed into a 952 summing amplifier. This is then integrated by 953 integrator and enters a 954 comparator which outputs a 0 or 1 depending whether the output of the integrator is below or above the comparator's threshold.

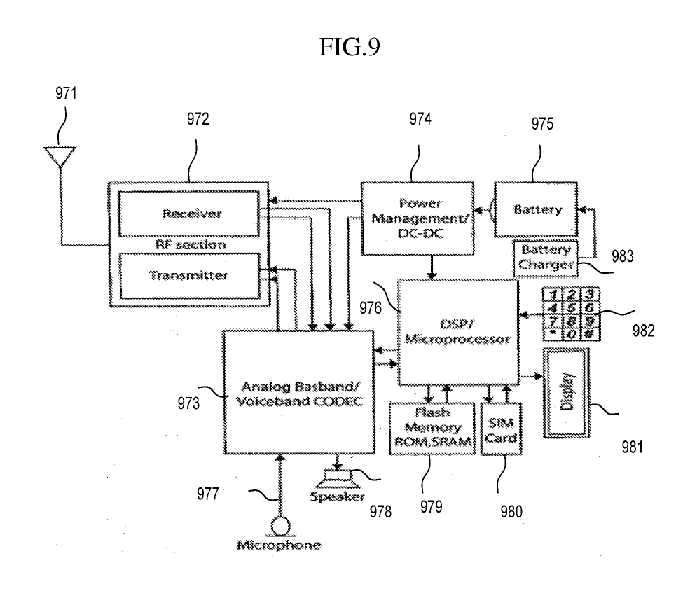

FIG. 9 illustrates a block diagram typical of the major functional blocks of a cellular telephone of the type not having the noise reduction and cancellation. This architecture is described so that the manner in which the invention interoperates with and improves the performance communication devices may be better understood. The antenna, 971, receives the signal and sends it to the RF section, 972. 973 is the analog baseband/voiceband CODEC. 977 is the microphone of the cellular telephone. Power management is done in 974. 975 and 983 are the battery and battery charger respectively of the cell phone. 982 is the keypad of the cell phone. 981 is the display screen of the cell phone. 980 is the slot for the SIM card. 979 is the Flash memory (ROM, SRAM). 976 is the DSP/Microprocessor. 978 is the speaker of the cell phone.

While the invention has been described with reference to a detailed example of the preferred embodiment thereof, it is understood that variations and modifications thereof may be made without departing from the true spirit and scope of the invention. Therefore, it should be understood that the true spirit and the scope of the invention are not limited by the above embodiment, but defined by the appended claims and equivalents thereof.

Unless the context clearly requires otherwise, throughout the description and the claims, the words “comprise,” “comprising” and the like are to be construed in an inclusive sense as opposed to an exclusive or exhaustive sense; that is to say, in a sense of “including, but not limited to.” Words using the singular or plural number also include the plural or singular number, respectively. Additionally, the words “herein,” “above,” “below,” and words of similar import, when used in this application, shall refer to this application as a whole and not to any particular portions of this application.

The above detailed description of embodiments of the invention is not intended to be exhaustive or to limit the invention to the precise form disclosed above. While specific embodiments of, and examples for, the invention are described above for illustrative purposes, various equivalent modifications are possible within the scope of the invention, as those skilled in the relevant art will recognize. For example, while steps are presented in a given order, alternative embodiments may perform routines having steps in a different order. The teachings of the invention provided herein can be applied to other systems, not only the systems described herein. The various embodiments described herein can be combined to provide further embodiments. These and other changes can be made to the invention in light of the detailed description.

All the above references and U.S. patents and applications are incorporated herein by reference. Aspects of the invention can be modified, if necessary, to employ the systems, functions and concepts of the various patents and applications described above to provide yet further embodiments of the invention.

These and other changes can be made to the invention in light of the above detailed description. In general, the terms used in the following claims, should not be construed to limit the invention to the specific embodiments disclosed in the specification, unless the above detailed description explicitly defines such terms. Accordingly, the actual scope of the invention encompasses the disclosed embodiments and all equivalent ways of practicing or implementing the invention under the claims.

While certain aspects of the invention are presented below in certain claim forms, the inventors contemplate the various aspects of the invention in any number of claim forms. Accordingly, the inventors reserve the right to add additional claims after filing the application to pursue such additional claim forms for other aspects of the invention.

What is claimed is:

1. A method of increasing SNR by alternating the sources of spatially separated sound inputs, storing the inputs, and reducing the background noise by use of existing multi-channel algorithms.

2. The method of claim 1 comprising the use of a relay to alternate the sources of spatially separated sound inputs.

3. The method of claim 2 comprising the use of an analog relay to alternate the sources of spatially separated sound inputs.

4. The method of claim 2 comprising the use of a digital relay to alternate the sources of spatially separated sound inputs.

5. The method of claim 1 comprising the use of one or more transistors to alternate the sources of spatially separated sound inputs.

6. The method of claim 1 comprising the use of a one or more flip flops to alternate the sources of spatially separated sound inputs.

7. The method of claim 1 comprising the use of an ADC clock to time the switching between the sources of spatially separated sound inputs.

8. The method of claim 7 comprising the use of a sigma-delta ADC to time the switching between the sources of spatially separated sound inputs.

9. The method of claim 1 used as means to increase the traffic on a communications network.

10. A device for increasing SNR by alternating the sources of spatially separated sound inputs comprising:
a) one or more microphones;
b) means of switching between the inputs of the microphones;
c) means of storing the inputs entering the microphones; and
d) means of using the stored inputs to increase the SNR.

11. The device of claim 10 comprising the use of one or more relays as means of switching between the inputs of the microphones.

12. The device of claim 10 comprising the use of one or more transistors as means of switching between the inputs of the microphones.

13. The device of claim 10 comprising the use of one or more flip-flops as means of switching between the inputs of the microphones.

14. The device of claim 10 comprising the use of one or more sigma-delta ADCs as means of timing the switching between the inputs of the microphones.

15. The device of claim 10 used to adjust the traffic on a communications network.

16. A communications network comprising means of tracking the use of the devices of claim 10 so as to increase the use of the network.

17. The network of claim 16 with means of tracking the use of any communication device with enhanced SNR capability so as to optimally adjust the number of network users.
